(19) United States
(12) Patent Application Publication
(10) Pub. No.: US 2006/0053936 A1
(43) Pub. Date: Mar. 16, 2006

(54) Variable ratio hand twist throttle cable pulley

(76) Inventor: Daniel V. Wancket, Rock Falls, IL (US)

Correspondence Address: GARY J. GIBBS, 715 VALLEY CREST DR., OCEANSIDE, CA, 92054, US

(21) Appl. No.: 10/920,128

(22) Filed: Aug. 17, 2004

(51) Int. Cl. F16C 1/12

(52) U.S. Cl. 74/501.6

(57) ABSTRACT

An improved motorcycle, or the like, hand twist throttle cable pulley for attachment to Bowden cable in which pulley has a non-circular shape providing a variable ratio between rotation of hand twist throttle and opening and closing of engine carburetion.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

This invention relates to motor vehicles with hand twist throttles, specifically to the cable pulley located inside hand twist throttle assemblies.

2. Background of the Invention

Many machines and vehicles, and in particular motorcycles, employ handlebars as a means or device for steering said machine or vehicle. Hand twist throttles are typically located on these handlebars to control engine acceleration and speed and thereby machine or vehicle acceleration and speed. Present hand twist throttles typically include a circular cable pulley which, connected to an engine carburetor by a Bowden cable or the like, provide a linear ratio between hand twist throttle rotation and carburetor control of the flow of fuel/air mixture to the engine combustion chamber. As the operator rotates the hand twist throttle throughout it's full range, the carburetor opens, and the engine accelerates, at a linear rate.

In certain conditions using circular cable pulleys, it can be difficult to control this flow of fuel/air mixture to the engine combustion chamber, and thus, it can be difficult to control operation of the machine. This is most evident in the closed to one-half open range of the carburetor, as this range is where throttle control can be most difficult, since it is most often within this range that traction control is vital in turning, off cambered slopes and other slippery conditions where a slight over-rotation of hand twist throttle can cause too much engine acceleration which in turn can cause a loss in traction and vehicle or machine control.

Present hand twist throttles provide only one circular cable pulley that will work for a specified machine model. This does not allow operator to change cable pulley size as riding conditions change. For example, a rider may choose a certain cable pulley ratio for good traction conditions such as wet sand or loam, yet choose a different cable pulley ratio for poor traction such as mud or hard ground. Present cable pulleys are not versatile enough to provide operator with adequate throttle control for changing conditions.

Several types of hand twist throttles have been proposed using cable pulleys-for example, U.S. Pat. No. 4,461,189 to Rottenkolber et al. (1984) and U.S. Pat. No. 4,352,303 to Christner (1982) both show cable pulleys. Both inventions utilize circular cable pulleys transmitting throttle rotation movement, via a Bowden cable, to carburetor opening and closing in a linear ratio. Christner's invention provides two cable pulley keyhole options for Bowden cable attachment, which allows operator to choose between two different ratios. Both options are circular. Typically, hand twist throttles rotate approximately 90 degrees, or one quarter of a full rotation, to adjust the carburetor from fully closed to fully open. The smaller diameter cable pulley option of Christner's invention does allow for a change in ratio which provides the operator an increase in hand twist throttle control. However, the circular smaller diameter option requires the operator to turn the hand throttle farther than 90 degrees, or one quarter of full rotation, to open carburetor fully. This additional turning puts the operator's wrist in position vulnerable to injury and excessive tiring especially noticeable in rigorous operation such as racing. Moreover, many operators with limited wrist flexibility are unable to rotate hand twist throttle far enough to cause carburetor to open fully. This can cause risk of injury as operator must continually release and reposition hand to rotate hand twist throttle far enough to open or close carburetor fully.

Cable pulleys are most often manufactured through plastic injection. However, they can also be produced by machining, casting or forging metals, or machining plastic or nylon materials.

### BACKGROUND OF INVENTION—OBJECTS AND ADVANTAGES

Objects and advantages of the present invention are:
(a) to provide a variable ratio between hand twist throttle rotation and carburetor opening.
(b) to provide interchangeable, different shaped cable pulleys to allow operator to change ratio between hand throttle rotation and carburetor opening and closing for different environmental conditions.
(c) to provide a means to change ratio between hand throttle rotation to carburetor opening and closing without substantially increasing hand twist throttle rotation distance.

### SUMMARY OF INVENTION

The present invention is directed toward overcoming the discussed shortcomings of prior art. These shortcomings are eliminated by changing the cable pulley shape from circular, as with prior art, to a non-circular shape. This shape would have a smaller diameter at point of Bowden cable attachment. This diameter would increase throughout the usable contact surface between the cable pulley and Bowden cable.

The improved cable pulley shape of invention has shown to provide improved operator hand twist throttle control by providing a variable ratio. By changing cable pulley to a non-circular shape, the operator is provided the necessary ratio to better control acceleration when the carburetor is in the closed to approximately one-half open range, yet changing this ratio when the carburetor is in the approximately one-half to fully opened range. This change in ratio allows better operator control of the machine.

In addition, said invention keeps hand twist throttle rotation from increasing substantially greater than 90 degrees, or one quarter of full rotation. This provides superior safety and comfort as compared to hand twist throttles where full rotation is substantially greater than 90 degrees or one quarter of full rotation. An operator with normal flexibility can rotate hand twist throttle utilizing present invention far enough without changing grip and jeapordizing vehicle control. Operator will also benefit from decreased fatigue and decreased risk of injury as wrist will not need to bend too far.

### BRIEF DESCRIPTION OF THE DRAWINGS

FIG. 1 shows shows a persective view of a hand twist throttle.

FIG. 2 shows an exploded perspective view of a hand twist throttle

FIG. 3 shows front view of prior art cable pulley

FIG. 4 shows front view of invention

### DESCRIPTION OF THE PREFERRED EMBODIMENT

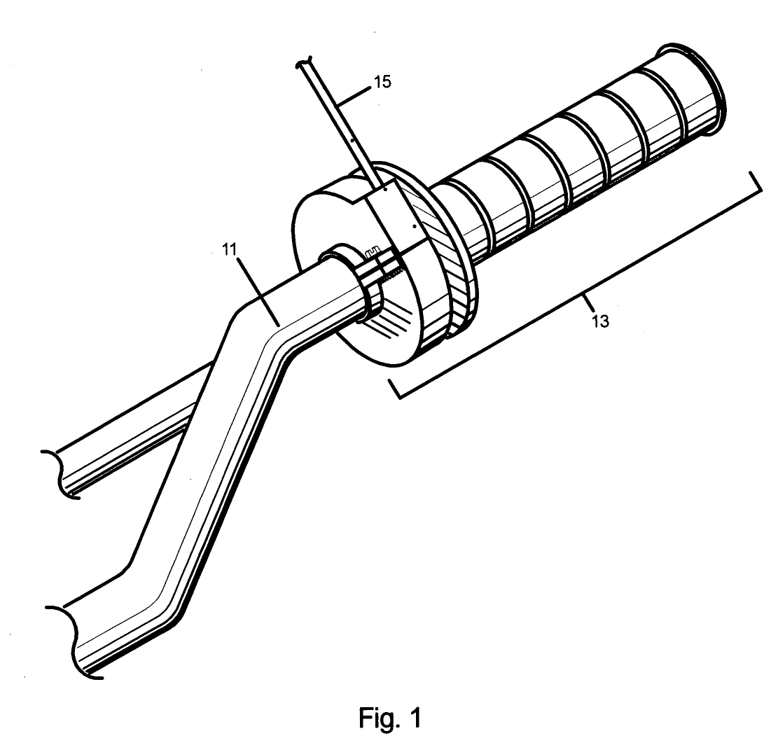

FIG. 1 shows the right side of a handlebar 11 of a motor-driven vehicle made in the conventional manner from metal tubing. A hand twist throttle assembly 13 is attached to handlebar 11. This hand twist throttle assembly is connected to engine carburetion by a Bowden cable 15.

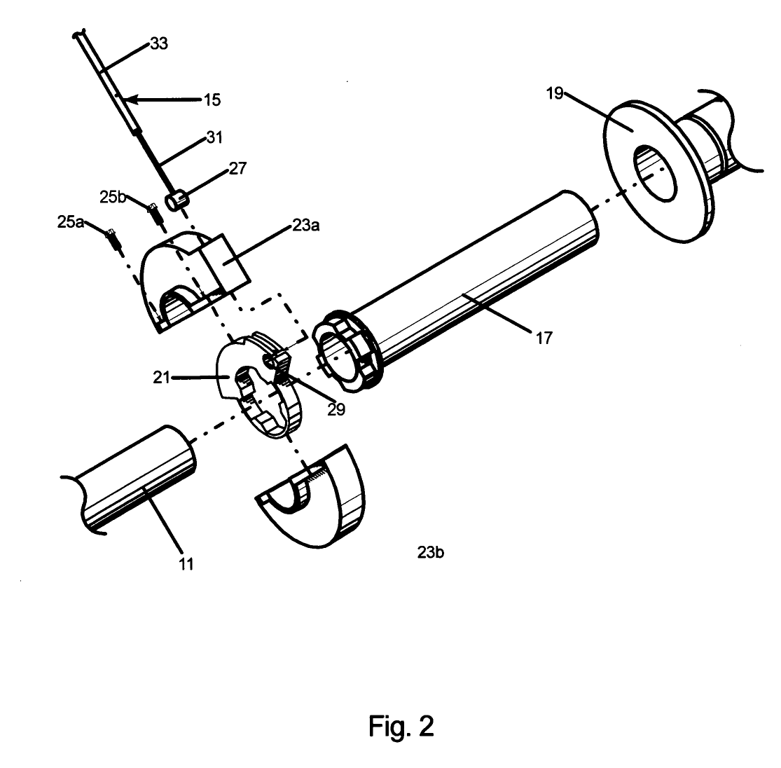

FIG. 2 shows an exploded view of said hand twist throttle assembly. A tube 17, made of plastic or aluminum, is mounted rotatably on handlebar 11, on which tube a sleeve 19 made of rubber or the like is placed so as to be rigidly fixed thereon. A cable pulley 21 is fitted to sleeve 17 by means of a spline pattern or the like. This sleeve 19 is gripped with the right hand of the operator. As operator rotates sleeve 19, tube 17 and cable drum 21 will likewise rotate.

A housing comprising of two halves 23a and 23b surrounds and axially fixes cable pulley 21 and exposed area of tube 17 which protrudes from sleeve 19. Housing halves 23a and 23b are rigidly fastened by means of screws 25a and 25b to handlebar 11. Bowden cable 15 is inserted into housing 23a wherein cable barrel 27 securely fits into keyhole 29 of cable pulley 21.

As operator grips and rotates sleeve 19, likewise tube 17 and cable pulley 21 will rotate. This action will pull cable barrel 27 affixed to keyhole 29, which will cause inner cable 31 to slide inside cable housing 33. Thus with the turning of sleeve 19, tube 17 and cable pulley 21, inner cable 31 will wind on to or off of cable pulley 21 so as to control opening and closing of engine carburetor, thus controlling engine acceleration and vehicle speed in the manner known per se.

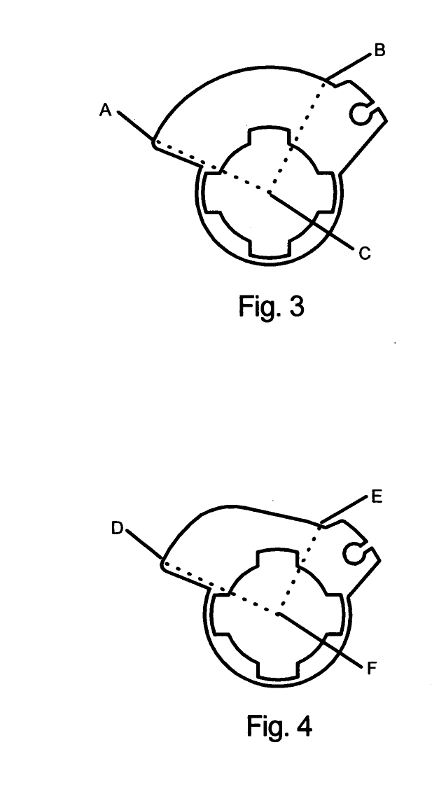

FIG. 3 shows a side view of prior art cable pulley. Note that Bowden inner cable contacts cable pulley from points A to B. Notice that distance from center C to B is equal to distance from center C to A.

FIG. 4 shows a side view of present invention. Note that Bowden inner cable contacts cable pulley from points D to E. Note that distance from center F to E is substantially less than distance from center F to D.

Operations—FIGS. 2,3,4

The results obtained utilizing present invention are significantly improved over use of prior art. Using prior art, operator grips and rotates sleeve 19 (FIG. 2), likewise tube 17 and cable pulley 21 will rotate. This action will pull cable barrel 27 affixed to keyhole 29, which will cause inner cable 31 to slide inside cable housing 33. Thus with the turning of sleeve 19, tube 17 and cable pulley 21, inner cable 31 will wind on to or off of prior art cable pulley 21 approximately from point B to A (FIG. 3). The result is a linear ratio between hand throttle rotation and carburetor opening and closing. In comparison, inner cable 31 will wind on to or off of present invention (FIG. 4) from point E to D. The result is a variable ratio between hand throttle rotation and carburetor opening.

Advantages

From the description above, a number of advantages become evident:
(a) With the use of interchangeable cable pulleys, the operator can change the ratio between hand throttle rotation and carburetor opening, and thus, improve control for varying environmental conditions.
(b) With the use of a non-circular shaped cable pulley, the ratio between hand throttle rotation and carburetor opening can vary throughout hand throttle rotation. This allows for the best ratio at different degrees of rotation.
(c) With the use of a non-circular shaped cable pulley, the ratio between hand throttle rotation and carburetor opening can be changed without a significant increase in distance of hand throttle rotation as necessary with prior art. This eliminates the need for operator to release and reposition grip on the hand throttle to complete rotation distance which changes carburetor from fully closed to fully open. This also reduces fatigue since wrist is not required to rotate hand throttle significantly farther than prior art.

I claim:

1. A hand twist throttle cable pulley with a contact area for Bowden or similar style cable that varies in predetermined distances from center of cable pulley to different points of said cable contact area, whereby a variable ratio is provided between hand throttle rotation and carburetor opening and closing.
